(19) United States
(12) Patent Application Publication
(10) Pub. No.: US 2012/0199683 A1
(43) Pub. Date: Aug. 9, 2012

(54) REEL APPARATUS HAVING A CORE PLUG FOR FACILITATING ASSEMBLY

(75) Inventors: Gary L. Cox, Richmond, IN (US); Gerald H. Davis, Fountain City, IN (US)

(73) Assignee: VANDOR CORPORATION, Richmond, IN (US)

(21) Appl. No.: 13/288,015

(22) Filed: Nov. 2, 2011

Related U.S. Application Data
(60) Provisional application No. 61/409,394, filed on Nov. 2, 2010.

(51) Int. Cl. B65H 75/14; B23P 11/00

(52) U.S. Cl. 242/118.62; 242/118.6; 29/525.01

(57) ABSTRACT

A reel assembly includes first and second flanges, a core body disposed between the first and second flanges, and a core plug. The core body has a central axis extending in a longitudinal direction between the first and second flanges. The core plug is coupled to the core body, and includes at least a first structure disposed at least in part radially inward of the core body toward the central axis. A plurality of fasteners couples the first flange to the first structure.

This application claims the benefit of U.S. Provisional Patent Application Ser. No. 61/409,394, filed Nov. 2, 2010, which is incorporated herein by reference.

### FIELD OF THE INVENTION

The present invention relates generally to reels for supporting wound flexible media such as cable, wire, hose, rope and the like.

### BACKGROUND OF THE INVENTION

Reels for supporting wound flexible media are available in a variety of sizes. However, for cabling and other industrial and business uses, reels can have on the order of 11 to 14 inch radii. Two common constructions of reels of this size include wooden and plastic reels. Wooden reels typically include flanges constructed of plywood, and a reel which may be of a number of materials.

A typical reel consists of two flanges attached to a central core around which the flexible media is wound. The core is often constructed of a tube of heavy paper. However, plastic cores can also be used. One of the basic issues in reel construction is the method and arrangement for connecting the flanges to the core. In some reels, it is common to bolt the flanges to each other using a long bolt that extends through the interior of the core structure, trapping the core between the two bolted flanges.

While such an arrangement is sufficiently strong, it can nevertheless be relatively time-consuming and inconvenient to assemble. The long bolts must be aligned with holes in both flanges, which involves alignment of the bolt without the benefit of seeing the point of entry on the second flange. Also, the through-bolt method requires manipulation of both flanges of a large reel.

Other methods involve the use of adhesive, which is not convenient to handle, and typically must be carried out before shipment. Requiring assembly of the reel before shipment can add to shipment costs. Yet another method employs staples to attach the flange to the core. Such a method is not always reliable. Still other methods involve spin welding of a flange to a plastic core. These methods strictly require the use of plastic materials for both the flange and the core.

There is a need, therefore, for a reel assembly that avoids disadvantages of using throughbolts without limiting the choice of materials to plastic for both core and flange, and without necessarily requiring full assembly of the reel before shipment.

### SUMMARY

At least one embodiment described herein address the above-described issues by providing a reel core with an end plate or plug that may be secured to a flange of any suitable material using fasteners connected directly to the end plate or plug.

In one embodiment, a plastic extruded tube has an end plate or plug spun-weld or otherwise secured to each end thereof. The end plate includes bores for receiving fasteners. In the constructed reel, a flange is placed over each of the end plates, typically one at a time, and then coupled to the end plate via fasteners. The fasteners may be bolts that extend through suitable openings in the interior of the flange and into holes in the end plates. As the bolts are rotated within the bore, they catch and self-tap into the end plate holes.

Another embodiment includes is a reel assembly that includes first and second flanges, a core body disposed between the first and second flanges, and a core plug. The core body has a central axis extending in a longitudinal direction between the first and second flanges. The core plug is coupled to the core body, and includes at least a first structure disposed at least in part radially inward of the core body toward the central axis. A plurality of fasteners couples the first flange to the first structure.

As a consequence, the inconvenience of assembly the long through-bolts is avoided because the fasteners may be much smaller, and the each of the flanges may be attached in a separate step. Also, by securing the flange to the end plate or plug, as opposed to the core body itself, the material used for the flange is irrelevant. Accordingly, the same core body and core plate/plug may be used with wooden, plastic and corrugated paper flanges. Finally, because the flange is easily secured via fasteners, the flange need not be assembled onto the reel prior to shipment to a customer.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a perspective view of an exemplary embodiment of a reel according to the invention;

FIG. 2 shows an exploded view of the reel of FIG. 1;

FIG. 3 shows a top plan view of an exemplary embodiment of the core plug of the reel of FIG. 1;

FIG. 4 shows a bottom plan view of the core plug of FIG. 3;

FIG. 5 shows a top perspective view of the core plug of FIG. 3.

FIG. 6 shows a fragmentary cutaway view of the core plug of FIG. 3 taken along VI-VI;

FIG. 7 shows a fragmentary cutaway view of an alternative arrangement of a flange, a core plug and fastener according to an embodiment of the invention.

### DETAILED DESCRIPTION

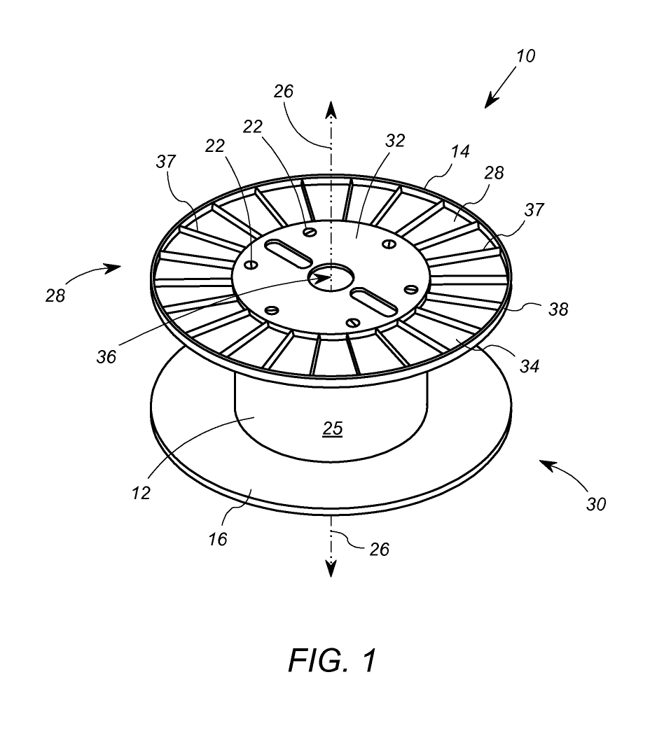

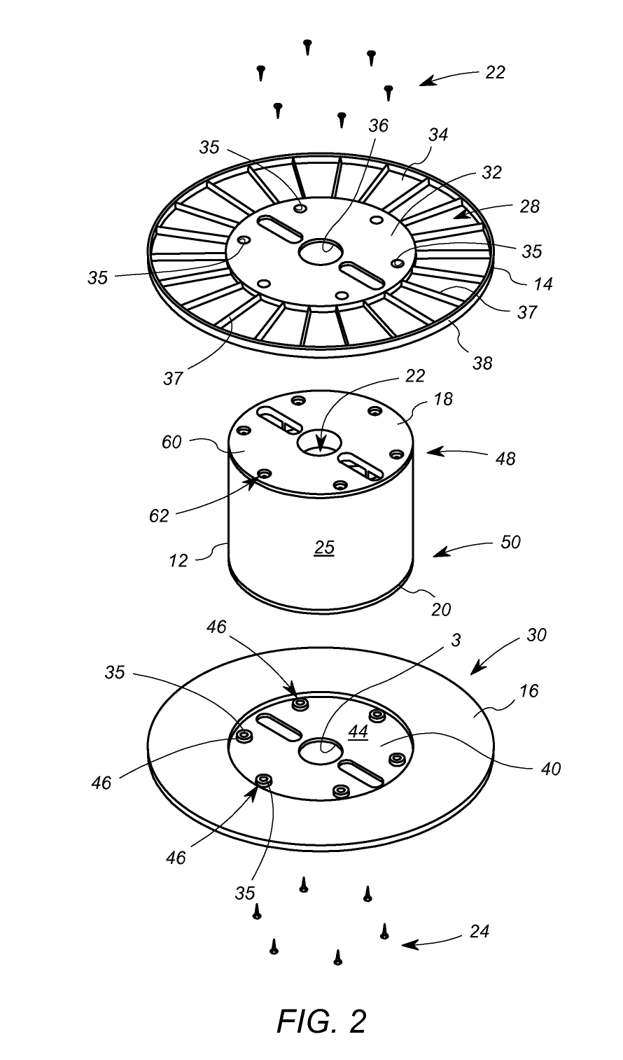

FIGS. 1 and 2 show a reel 10 according to a first embodiment of the invention. In FIG. 1, the reel 10 is completely assembled. FIG. 2 shows partially exploded view of the reel 10. Referring to FIGS. 1 and 2, the reel 10 includes a core body 12, a first flange 14, a second flange 16, a first plug 18, a second plug 20, and a plurality of fasteners 22, 24. It will be appreciated that the second plug 20 is largely obscured from view in FIG. 2, but has the same structure as the first plug 18.

In the embodiment of FIGS. 1 and 2, the core body 12 is a substantially cylindrical body having an interior 22, and a cylindrical wall 25 that forms the surface upon which flexible media may be wound. The core body 12 is disposed between the first and second flanges 14, 16. The core body 12 has a central axis 26 extending in a longitudinal direction between the first and second flanges 14, 16. The core body 12 may suitably be an extruded plastic tube.

The first and second flanges 14, 16 in this embodiment have an identical structure. It will be appreciated, however, that the first and/or second flanges 14, 16 may have different structures than that shown in FIGS. 1 and 2, or and even different than each other. FIGS. 1 and 2 show a first side or outer side 28 of the first flange 14 and a second or inner side 30 of the second flange. The first flange 14 also has an inner side, not shown, substantially identical to the inner side 30. Similarly the second flange 16 has an outer side, not shown, substantially identical to the outer side 28.

In this embodiment, each of the first and second flanges 14, 16 is constructed of molded plastic, as are the plugs 18 and 20. The outer side 30 of the flange 14 includes an inner core portion 32 and an outer flange portion 34. The inner core portion 32 is concentrically aligned with the core body 12 and includes a plurality of circumferentially fastener holes 35 defined therein. The inner core portion 32 also includes an arbor hole 36 through which an axle, not shown, may be placed to facilitate rotation of the reel 10. The outer flange portion 34 comprises an annular plate that has sufficient thickness and strength to provide axial retention of wound media, not shown, on the core body 12. Many suitable plastic flange structures are known. In this example, the outer flange portion 34 includes a plurality of circumferentially spaced, radial ribs 37 that extend from the outer radial edge of the inner core portion 32 to an outer annular rim 38.

The inner side 28 also includes an inner core portion 40 and an outer flange portion 42. The inner core portion includes a plate-like surface 44 and a plurality of bosses 46 aligned with the fastener holes 35. The bosses 46 form a raised tubular periphery to the fastener holes 35 that extend axially from the plate-like surface 44.

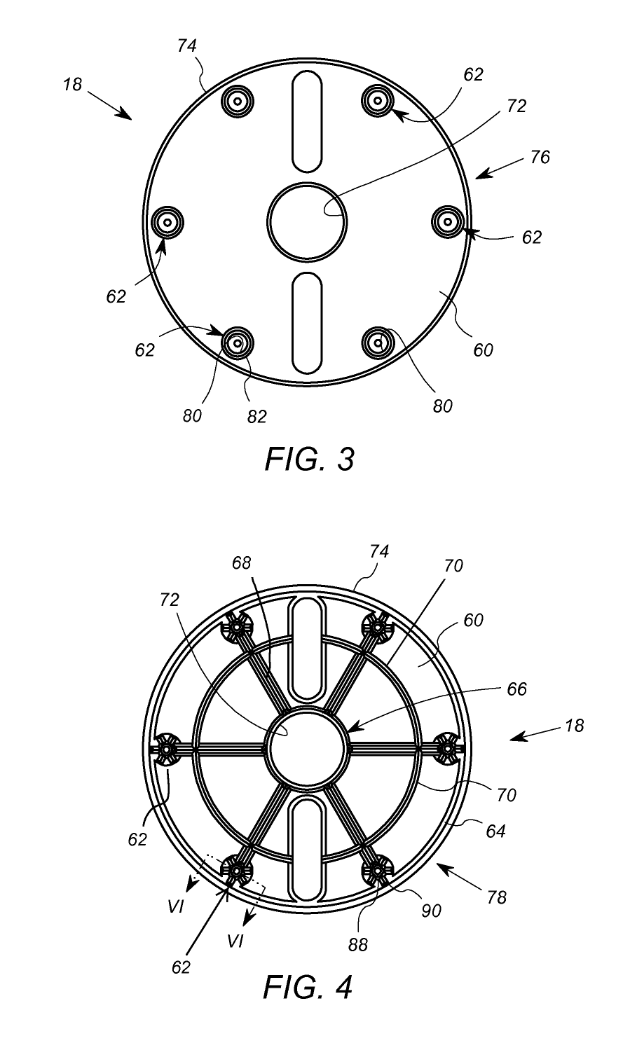

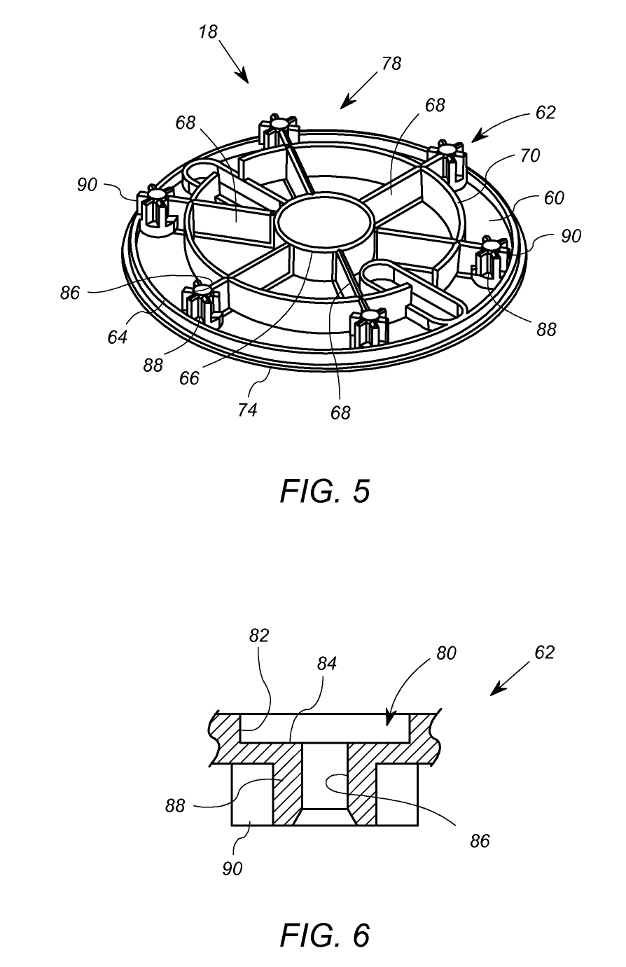

The core plug 18 is a structure that is coupled to a first end 48 of core body 12. The core plug 20 is a substantially identical structure that is coupled to the second end 50 of the core body 12. Referring to FIGS. 3, 4 and 5 contemporaneously, the core plug 18 in this embodiment comprises a plate 60, six receptacle structures 62, an outer rim or ridge 64, an arbor hole rim 66, a set of radial ribs 68, and a intermediate annular rim 70. The core plug 18 is formed of plastic and may be coupled to the core body 12 (see FIG. 2) using an adhesive or spin welding techniques. The core plug 18 has a first side 76 shown in FIG. 3 (and FIG. 2) and a second side 78 that is shown in FIGS. 4 and 5.

The plate 60 is substantially circular in shape and has a diameter defined by an outer edge 74 that roughly equals that of the core body 12. The plate 60 includes a central arbor hole 72 that corresponds and aligns with the arbor hole 36 of the flanges 14, 16. The outer annular rim 64 extends axially from the second side 78 of the plate 60, and is slightly inward of the outer edge 74. The outer annular rim 64 has an outer diameter that engages the inner surface of the cylindrical wall 25 of the core body 12 when inserted therein. In the assembled structure shown in FIG. 2, for example, the outer annular rim 64 is not visible on either core plug 18 and 20 because in both cases it is within the interior 22 of the core body 12.

Referring again to FIGS. 3, 4 and 5, the arbor hole rim 66 extends axially from the second side 78 of the plate 60, and extends around the periphery of the arbor hole 72. The intermediate annular rim 70 also extends axially from the second side 78 of the plate 60, and is disposed concentrically between the outer annular rim 64 and the arbor hole rim 66. The radial ribs 68 likewise extend axially from the second side 78 of the plate 60, and extend radially from the arbor hole rim 66 through the intermediate annular rim 70 and terminate at the receptacle structures 62.

The receptacle structures 62 are shown in further detail in cross section in FIG. 6. With reference to FIGS. 3, 4 and 6, the receptacle structures 62 are disposed axially inward of, but preferably proximate to, the outer edge 74 of the plate 60, and are spaced apart circumferentially about the plate 60. It will be appreciated that more or fewer receptacle structures 62 may be employed to suit the design (strength/cost) criteria of the reel 10.

On the first side of the plate 60, each receptacle structure 62 includes a recess 80 and having a side wall 82 and a bottom wall 84, with a bore 86 defined through the bottom wall 84. The recess 80 and side wall 82 are configured to receive and engage one of the raised bosses 46 of the flanges 14, 16. In such position, each of the fastener holes 35 in the flange 14, 16 aligns with a corresponding bore 86. Accordingly, in the embodiment described herein, the recess 80 and bosses 46 provide an alignment mechanism to ease assembly of the flanges 14, 16 onto the core body 12 and core plugs 18, 20.

It will be appreciated that if wood or paperboard flanges are used instead of the plastic flanges 14, 16, then the bosses 46 will not exist and traditional visual alignment means may be employed to ensure that holes in the flanges align with the bores 86 of the receptacle structures 62.

As shown in FIGS. 4 and 5, the receptacle structures 62 also include an axial bore support or tube 88 and a plurality of radial buttresses 90 that extend from the second side 78 of the plate 60. The axial bore tube 88 provides additional structural support to increase the length of the bore 82. In general, the ribs 68, rims 66 and 70, tube 88 and radial buttresses 90 may all extend to substantially the same axial height.

To construct the reel 10, the core body 12, the flanges 14, 16 and the core plugs 18 and 20 are first obtained. The core plugs 18 and 20 are secured to respective ends 48, 50 of the core body 12, with the outer annular rim 64 of the core plugs 18 and 20 disposed within the tube wall 25 and outer edge 74 of the plate 60 abutting the axial end of the tube wall 25. To secure the core plugs 18, 20, conventional spin welding or adhesives may be used. Well-known spin welding techniques are described, for example, in U.S. Pat. Nos. 6,102,327 and 7,534,316, both of which are incorporated herein by reference.

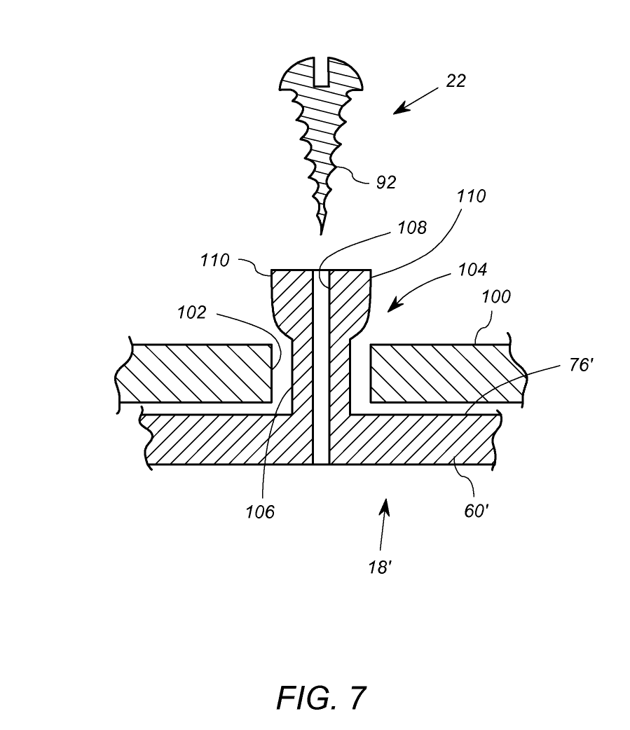

Thereafter, for example, after shipment of the assembled core body 12 and core plugs 18, 20 and the unassembled flanges 14 and 16, the flanges 14, 16 may be secured to the plates 60 of the core plugs 18, 20. To this end, the first flange 14 is disposed adjacent the first end 48 of the tube body 12 such that the raised bosses 46 are received into the recesses 80 of the plate 60. The fasteners 22 are then rotatably inserted into the fastener hole 35 and bore 86. In the embodiment described herein, the inner diameters of the fastener hole 35 and the bore 86 are smaller than a diameter of the fasteners 22 (and fasteners 24), specifically with respect to the threaded portions 92 of the fasteners 22, 24. (See fastener 22 of FIG. 7). In this manner, the fastener, which may suitably be a self-tapping screw or bolt, engages and creates a self-tapping connection with the interior of the wall 88 of receptacle structure 62 and of the boss 46.

The second flange 16 is coupled against the second end 50 of the tube body in an analogous manner.

The use of the plate 60 and the receptacle 62 of the plugs 18 and 20 allows for application of different materials for flanges. Plastic flanges such flanges 14, 16 may be used as disclosed. However, wooden flanges may instead be used, simply by drilling holes in the flange, and aligning the drilled holes with the bores 86 in the plate 60. In such a case, it may be preferably to employ a washer between the head of the fastener and the flange surface. A similar technique can be used to attach a corrugated paper flange against the core body 12.

In another embodiment, the receptacle structure is designed to fit through a hole in a flange and to self-separate once the fastener is inserted thereto. For example, FIG. 7 shows a fragmentary cross-section of an alternative connection arrangement that includes a flange 100 and an alternative embodiment of a receptacle structure 104 that may be employed in place of the receptacle structure of 62. The view of FIG. 7 may suitably be a sectional view similar to view VI-VI of FIG. 6 in a modified version of the core plug 18′, placed in environment with a portion of a flange 100. The core plug 18′ may otherwise may have the same structure as the core plug 18, described further above. The flange 100 may suitable be a wooden, plastic or paperboard flange that includes a throughhole 102 that has a diameter that is equal to or larger than the threaded portion 92 of the fasteners 22, 24.

The alternative receptacle structure 104 of FIG. 7 extends from the plate 60′ outward of the first side 76′ of the core plug 18′. The receptacle structure 104 includes a stem 106 having a central bore 108. The central bore 108 has an inner diameter significantly smaller than the diameter of at least a majority of the threaded portion 92 of the fastener 22. At the top of at least two sides of the stem 106 include flared structures 110 that are configured to fit through the throughhole 102 when a fastener 22 is not inserted into the bore 108.

When the flange 100 is assembled onto the plate 60′, the flared structures 110 pass through the throughhole 102. When the fastener 22 is rotatably inserted into the bore 108 and advanced all or most of the way in, the stem 106 and flared structures 110 are urged radially outward (left and right in FIG. 7) such that the flared structures 110 extend over the flange 100 and can no longer pass through the throughhole 102. In such a position, the flange 100 is secured against the core body 12 and/or core plug 18′ without relying on a connection between the fastener 22 and the flange 100 itself.

It will be appreciated that the above-described embodiments are merely exemplary, and that those of ordinary skill in the art may readily devise their own implementations and modifications that incorporate the principles of the present invention and fall within the spirit and scope thereof.

We claim:

1. A reel assembly, comprising:
first and second flanges;
a core body disposed between the first and second flanges, the core body having a central axis extending in a longitudinal direction between the first and second flanges;
a core plug coupled to the core body, the core plug including at least a first structure disposed at least in part radially inward of the core body toward the central axis; and
a plurality of fasteners coupling the first flange to the first structure.

2. The reel assembly of claim 1, wherein the first structure comprises a plate member having a plurality of fastener receptacles formed therein.

3. The reel assembly of claim 2, wherein the fasteners are threaded fasteners.

4. The reel assembly of claim 3, wherein each of the fastener receptacles includes a bore and a receptacle wall, and wherein a threaded portion of the threaded fasteners engages the receptacle wall within the bore.

5. The reel assembly of claim 4, wherein the core plug and core body include a spin weld coupling.

6. The reel assembly of claim 5, wherein the core plug includes an annular rim extending from the plate member and engaging the core body.

7. The reel assembly of claim 1, wherein the core body is cylindrical in shape.

8. The reel assembly of claim 1, wherein the fasteners comprise threaded fasteners.

9. The reel assembly of claim 8, wherein the first structure includes a fastener receptacle wall and a bore, and wherein a threaded portion of the threaded fasteners engages the receptacle wall within the bore.

10. The reel assembly of claim 1, wherein the core plug and core body include a spin weld coupling.

11. The reel assembly of claim 10, wherein the core plug includes an annular rim extending from the plate member and engaging the core body.

12. A method of constructing a reel, comprising:
a) providing a core plug secured at least partially within a core body, the core plug including at least a first structure disposed radially inward of an external wall of the core body toward the central axis;
b) using at least a first fastener to couple a first flange to the first structure; and
c) securing a second flange adjacent the core body.

13. The method of claim 12, wherein step b) further comprises rotatably engaging the first structure with the first fastener.

14. A reel apparatus, comprising,
a plastic extruded tube having an end plate secured to each end thereof, the end plate including bosses receiving fasteners, the plastic extruded tube disposed between two flanges, the flanges secured to the end plates using said fasteners.

15. The reel apparatus of claim 14, wherein each of the flanges has a diameter that exceeds a diameter of the plastic extruded tube.

16. The reel apparatus of claim 15, wherein each of the flanges is constructed of plastic.

17. The reel apparatus of claim 15, wherein at least one of the flanges is constructed of wood material.

18. The reel apparatus of claim 15, wherein at least one of the flanges is constructed of a paperboard material.
